(19) United States
(12) Patent Application Publication
(10) Pub. No.: US 2018/0306657 A1
(43) Pub. Date: Oct. 25, 2018

(54) SYSTEM FOR FORMING A FLOOR FOR DETECTING A PRESSURE APPLIED THEREON, DEVICE FOR USE IN SUCH SYSTEM, CARPET TILE PROVIDED THEREWITH AND CONNECTION ELEMENT FOR SUCH CARPET TILE

(71) Applicant: TARKETT B.V., Waalwijik (NL)

(72) Inventor: Bertus Michiel WAGENAAR, Arnhem (NL)

(21) Appl. No.: 15/738,085

(22) PCT Filed: Jun. 8, 2016
(86) PCT No.: PCT/NL2016/050410

§ 371 Date: Dec. 19, 2017

(30) Foreign Application Priority Data
Jun. 19, 2015 (NL) 2014995

(51) Int. Cl. G01L 1/20; E04F 15/02; B32B 3/26; B32B 9/04

(52) U.S. Cl. CPC G01L 1/205; E04F 15/0215; G06F 3/0414; B32B 9/041; B32B 3/266

(57) ABSTRACT

Device for detecting pressure comprising a first foil layer with first and second electric conductors, electrically isolated from each other; a second foil layer, comprising an electric resistance; wherein the first and second layers are arranged on top of each other, such that the first and second electric conductors and the resistance face each other, wherein a projection of the location of the electrical resistance on the first layer covers an area to which both the first and second electric conductors extend; a separator, for keeping the first and second layers a distance from each other when there is no pressure applied; a first connector point, electrically coupled to the first electric conductor, and outwardly available at a first pair of opposite sides of the device; a second connector point, electrically coupled to the second electric conductor, and outwardly available at the second pair of opposite sides of the device.

The present invention relates to a system for forming a floor for detecting a pressure applied thereon, a device for use in such system, a flooring and a connection element for the device.

Detecting a pressure on a floor, in particular applied by a person walking, sitting or lying on said floor, may be found interesting for various reasons. The knowledge about the presence of a person may be used in order to create convenience for that person, for instance by automatically switching on lights or other equipment in the room where the person is, it may be used for safety reasons, as part of an alarm system, or for determining irregularities, such as a person fallen on a floor. More advanced systems may be used to keep track of persons, and to monitor their behaviour. This may be the case in a supermarket, or in other places where behaviour of a group of people is to be monitored.

Systems for at least some of the above mentioned purposes exist. However, they have various disadvantages. In particular, they set numerous requirements to the flooring that can be applied, and their modularity and scalability are often very poor, not in the last place due to technical complexity, with often high costs as a result. Other systems lack the possibility to be re-used in another configuration and/or location.

It is therefore a goal of the present invention to provide a system for forming a floor for detecting a pressure applied thereon, that takes away at least some of the above mentioned disadvantages, or that at least provides a useful alternative to the state of the art.

The invention thereto proposes a device for forming a floor for detecting a pressure applied thereon, comprising a first foil layer, provided with at least a first electric conductor and at least a second electric conductor, electrically isolated from each other; a second foil layer, comprising an electric resistance, wherein the first layer and the second layer are arranged on top of each other, such that the respective sides with the at least one first and second electric conductor and the resistance face each other, and wherein the device is dimensioned such that a projection of the location of the electrical resistance on the first layer covers an area to which both the at least one first and second electric conductor extend, a separator, for keeping the first and the second layer at least locally at a distance from each other when there is no pressure applied to the device; at least a first connector point, electrically coupled to the first electric conductor, and outwardly available at a first pair of opposite sides of the device; at least a second connector point, electrically coupled to the second electric conductor, and outwardly available at the second pair of opposite sides of the device.

The shape of the first and the second foil layers may be essentially rectangular, but other shapes like hexagons or circles are possible too. In particular shapes that can be combined in a pattern that covers a closed or almost closed area are preferred, wherein the use of multiple pieces with different shapes is possible too.

When a pressure is applied on a device according to the invention at the height of the first and the second electric conductor, said electric conductors are both pressed against the electric resistance. The resistance measured between the first and the second electric conductor decreases, in dependence of the pressure on the device. This way, not only a binary value representing the presence of a pressure (and thus an object or person) can be determined, but also the amount of pressure, which is related to the weight of the person or object. The first connector point and the second connector point are outwardly available at opposite sides of the device, so that with multiple devices according to the invention, an x times y matrix like grid can be formed, with x parallel lines of interconnected devices in a first direction, and y parallel lines of interconnected devices in a second direction, perpendicular to the first direction when their first connector points and the second connector points are interconnected.

The invention thereto also provides an interconnector, comprising a foil layer, at a first side thereof provided with an electric conductor, and an adhesive, provided at the second side thereof, for fixing the interconnector to a substrate, such as a floor. The electric conductor of the interconnector can be arranged against two outwardly available connector points of respective devices for forming a floor for detecting a pressure applied thereon as described above.

The invention may be applied with several types of flooring, such as carpet, vinyl flooring (homogeneous, heterogeneous LVT), linoleum, wood or laminate.

The invention further relates to a flooring part, such as a carpet tile comprising a carpet top layer, comprising poles, a carpet bottom layer, comprising a backing, or such as a laminate, marmoleum or linoleum piece, of which the respective backing on the side facing away from the poles or the back side is provided with a device for forming a floor for detecting a pressure applied thereon as described above. The flooring part and the device may be essentially same sized and/or shaped, and may be fixed or adhered to each other in order to facilitate a quick and easy placement.

Preferably, the combination of the first and second foil layers as a whole are water resistant, for instance by means of a printed non-conductor material. In a preferred embodiment, thereto, the first and the second foil layers and the interconnectors are provided with waterproof adhesives.

The invention also relates to a system for forming a floor for detecting a pressure applied thereon, comprising a plurality of adjacently arranged flooring parts as described above, a plurality of interconnectors as described above, wherein the respective first connector points and second connector points of adjacent flooring parts are mutually electrically connected by electric conductors of interconnectors, wherein each contact of a connector point of a flooring part and a conductor of an interconnector is provided with a conductive adhesive, for electrically and mechanically coupling the flooring parts and the interconnectors, such that all first electric conductors of flooring parts in adjacently arranged flooring parts in a first direction are electrically connected, and all second electric conductors of flooring parts in a second direction, perpendicular to the first direction, of adjacently arranged flooring parts are electrically connected.

This way an x times y matrix grid is formed, with x parallel lines of interconnected devices in a first direction, and y parallel lines of interconnected devices in a second direction, perpendicular to the first direction when their first connector points and the second connector points are interconnected. In order to detect a pressure or person, the matrix grid should be “scanned”.

For that purpose, the system may further comprise a controller, for subsequently measuring an electric resistance between combinations of electrically connected first electric conductors and electrically connected second electric conductors. The controller subsequently determines the resistance between each combination of rows x and y, as to obtain a map of the entire surface. The operation is repeated continuously, so that an actual overview of the presence of people or objects on the surface is available.

It has appeared that it is beneficial in a sense of noise reduction, in particular cross talk between lines, when the minimal electric resistance of the electrical connections of the first and second electric conductors of one tile together, is about a factor 1000 smaller than the minimal electric resistance of the second foil layer when a pressure is exerted on the tile.

Furthermore, in order to measure a resistance, a DC voltage has to be applied on the combinations of electrically connected first electric conductors and electrically connected second electric conductors. For this purpose, a linear (non-switched) power supply is preferred, which has no or very low ripple.

The controller is adapted to provide a data signal representing a pressure on each of the flooring parts, which may be used for multiple purposes, such as controlling further apparatus such as lights, for use in an alarm system, and for detecting irregularities such as fallen persons, on order to be able to provide first aid.

Both in the device and in the flooring part, the first electric conductor and the second electric conductor may be arranged as fingers that extend in between each other. This results in a short path through the resistance in case of a pressure, and enables a “sharp” detection. Although silver or copper may be considered as an evident choice for its electric properties, aluminium may be chosen here, for that material is easier to recycle. The resistance may comprise a carbon layer.

The separator may be embodied by multiple in particular non-conductive paint dots, arranged on at least one of the layers. Other separator shapes may be hexagonal grids or random lines.

For flooring parts, in particular carpet tiles may easily become charged with static electricity, it may be desired to provide an electrically conducting path from the outwardly facing sides from the first foil layer to the second foil layer of the device. Besides an electric wiring, this conducting path may also be formed by a through hole, when the flooring part itself is provided with a carbon or other type of conducting yarn, and conductive pathways for any layer thereunder.

The invention will now be explained in more detail with reference to the following figures.

Herein:

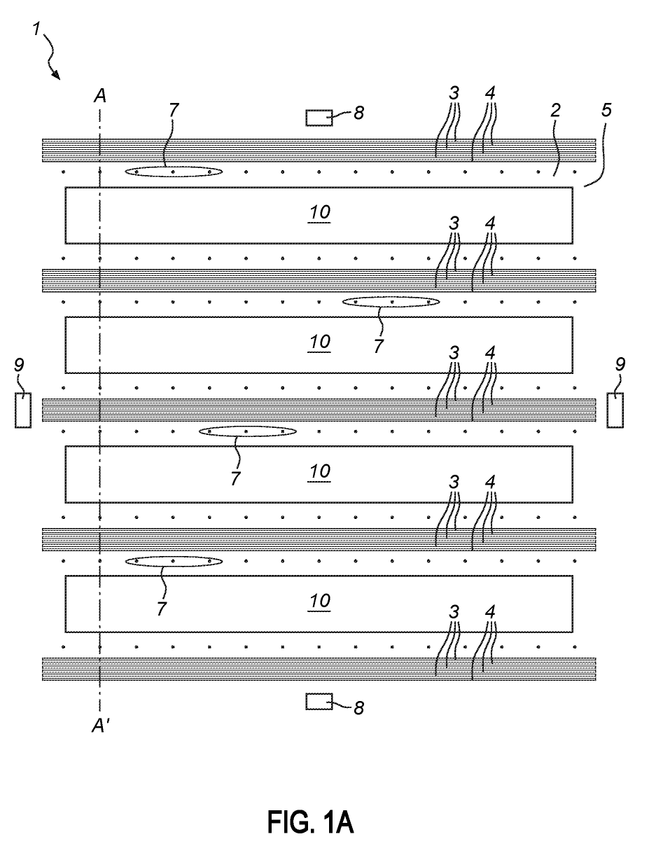

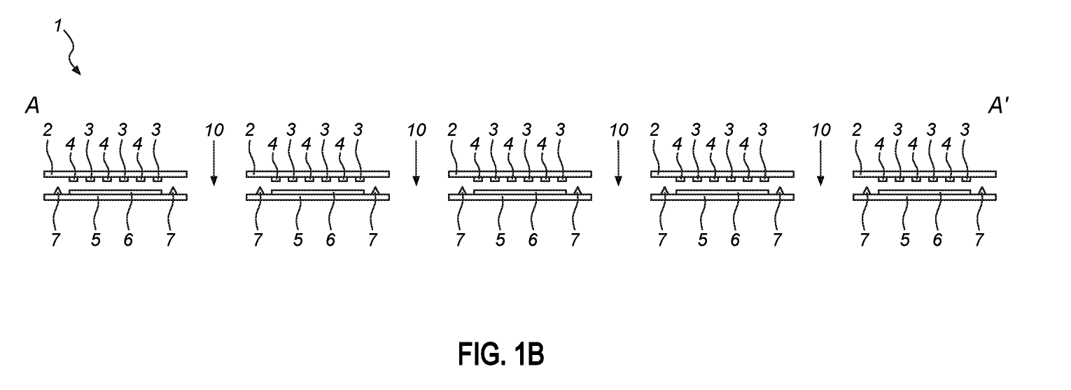

FIGS. 1a, b show a schematic top and cross sectional view of a device according to the present invention;

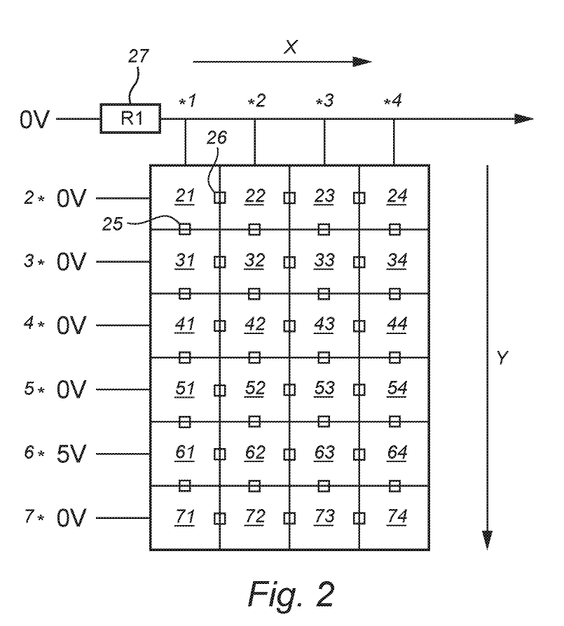

FIG. 2 shows a schematic view of a flooring according to the present invention; and

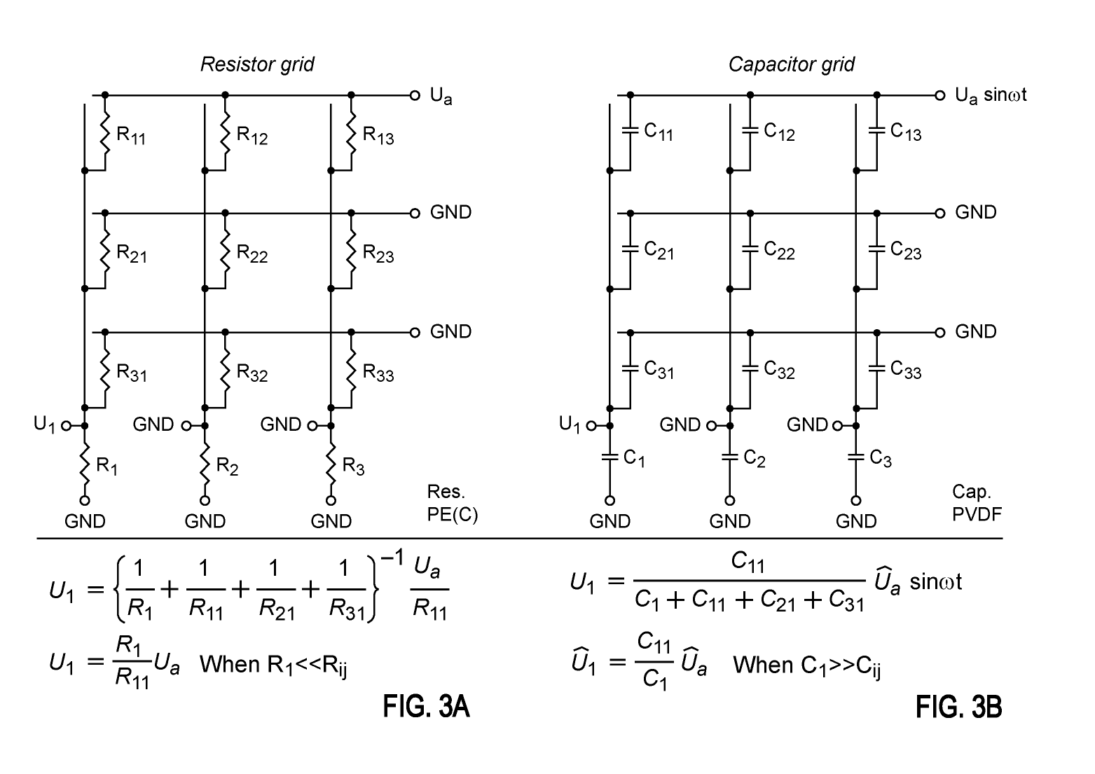

FIG. 3a, b show electric schemes of a floorings according to the present invention.

FIG. 1 shows a schematic view of a device 1 according to the present invention. The device 1 comprises a first essentially rectangular foil layer 2, provided with at least a first electric conductor 3 and at least a second electric conductor 4, electrically isolated from each other, a second essentially rectangular foil layer 5, comprising an electric resistance 6, wherein the first layer 2 and the second layer 5 are arranged on top of each other, such that the respective sides with the at least one first and second electric conductor 3, 4 and the resistance 6 face each other, and wherein the device is dimensioned such that a projection of the location of the electrical resistance on the first layer covers an area to which both the at least one first and second electric conductor extend. The device further comprises a separator 7, here embodied by a number of elevated spots, for keeping the first and the second layer 2, 5 at least locally at a distance from each other when there is no pressure applied to the device. The device further shows a first connector point 8, electrically coupled to the first electric conductor 3, and outwardly available at a first pair of opposite sides of the device 1, and a second connector point 9, electrically coupled to the second electric conductor 4, and outwardly available at the second pair of opposite sides of the device 1. The device comprises through holes 10, forming an electrically conducting path from the outwardly facing sides from the first essentially rectangular foil layer to the second essentially rectangular foil layer, which serves to enable grounding of the carpet tile.

FIG. 2 shows a schematic view of a flooring according to the present invention, wherein carpet tiles 21, 22, 23, 24, 31, 32, 33, 34, 41, 42, 43, 44, 51, 52, 53, 54, 61, 62, 63, 64, 71, 72, 73, 74 each provided with a device from FIG. 1 are arranged in a room, thus forming a flooring comprising seven rows, 2*, 3*, 4*, 5*, 6*, 7*, and four columns *1, *2, *3 and *4. the first connectors of tiles in the same row are mutually connected by interconnectors, like interconnector 25, and the second connectors of tiles in the same row are mutually connected by interconnectors, like interconnector 26.

A pressure on the flooring is determined by scanning the resistances of the devices corresponding with the respective flooring parts, which is done by sequentially connecting each combination of rows and columns to a voltage source, and determining the current that flows. This current may be determined indirectly, that is, by measuring the voltage over a resistance 27, that is coupled in series with the respective combinations of rows and columns.

FIG. 3a shows an electric scheme of a flooring according to the present invention, for a three times three matrix, and shows equations for determining the voltage measured over the resistance R1. The equation enables to determine the resistance corresponding with the device under a specific tile. With a predetermined relation between the resistance of the device and the pressure applied thereon, the weight of a person or object on the flooring part can be determined.

FIG. 3b shows an alternative electric scheme that can be used when instead of a resistance, a pressure or body dependent capacity is used. In that case, the use of an alternating reference voltage is preferred but not strictly necessary. With a predetermined relation between the capacity of the device and the pressure applied thereon, the weight of a person or object on the flooring part can be determined.

It should be noted that also an embodiment with solely a resistance can be used for measurements based on capacitive properties. In particular when the first electric conductor and the second electric conductor are arranged as fingers that extend in between each other, a body capacitance of a person approaching the device or carpet tile according to the invention van be determined, even before a pressure is exerted on the device or flooring part.

1. A system for forming a floor for detecting a pressure applied thereon, comprising:
a plurality of adjacently arranged flooring parts, each part comprising:
a flooring part layer, comprising a top side;
a back side, provided with:
a first foil layer, provided with at least a first electric conductor and at least a second electric conductor, electrically isolated from each other;
and a second foil layer, comprising an electric resistance;
wherein the first layer and the second layer are arranged on top of each other, such that respective sides with the at least one first and second electric conductor and the resistance face each other, and are dimensioned such that a projection of a location of the electrical resistance on the first layer covers an area to which both the at least one first and second electric conductor extend;
a separator, for keeping the first and the second layer at least locally at a distance from each other when there is no pressure applied to the flooring part;
and at least a first connector point, electrically coupled to the first electric conductor, and outwardly available at a first pair of opposite sides of the flooring part;
at least a second connector point, electrically coupled to the second electric conductor, and outwardly available at a second pair of opposite sides of the flooring part;
a plurality of interconnectors, the interconnectors each comprising:
a foil layer, at a first side thereof provided with an electric conductor, and an adhesive, provided at a second side thereof, for fixing the interconnector to a substrate
wherein all first electric conductors of flooring parts in adjacently arranged flooring parts in a first direction are electrically connected and all second electric conductors of flooring parts in a second direction of adjacently arranged flooring parts are electrically connected.

2. The system according to claim 1, wherein the respective first connector points and second connector points of adjacent flooring parts are mutually electrically connected by electric conductors of interconnectors, wherein each contact of a connector point of a part and a conductor of an interconnector is provided with a conductive adhesive, for electrically and mechanically coupling the flooring parts and the interconnectors.

3. The system according to claim 1, wherein the first direction of the first connectors and the second direction of the second connectors are under an angle, and are mutually perpendicular.

4. The system according to claim 1, further comprising a controller, for subsequently measuring an electric resistance between combinations of electrically connected first electric conductors and electrically connected second electric conductors.

5. The system according to claim 4, wherein the controller is adapted to provide a data signal representing a pressure on each of the flooring parts.

6. A flooring part for forming a floor for detecting a pressure, comprising:
a flooring part layer, comprising a top side;
a flooring bottom layer, comprising a backing, the backing on a side facing away from the top side provided with:
a first foil layer, provided with a first electric conductor and a second electric conductor, electrically isolated from each other;
a second foil layer, comprising an electric resistance;
wherein the first layer and the second layer are arranged on top of each other, such that the respective sides with the first and second electric conductor and the resistance face each other, and are dimensioned such that a projection of a location of the electrical resistance on the first layer covers an area to which both the first and the second electric conductor extend;
a separator, for keeping the first and the second layer at least locally at a distance from each other when there is no pressure applied to the flooring part;
at least a first connector point, electrically coupled to the first electric conductor, and outwardly available at a first pair of opposite sides of the flooring part;
and at least a second connector point, electrically coupled to the second electric conductor, and outwardly available at the second pair of opposite sides of the flooring part.

7. The flooring part according to claim 6, wherein the first electric conductor and the second electric conductor are arranged as fingers that extend in between each other.

8. The flooring part according to claim 6, wherein the first and/or second electric conductor comprises aluminum.

9. The flooring part according to claim 6, wherein the resistance comprises a carbon layer.

10. The flooring part according to claim 6, wherein the separator comprises paint dots, arranged on at least one of the layers.

11. The flooring part according to claim 6, comprising an electrically conducting path from the outwardly facing sides from the first foil layer to the second foil layer.

12. The flooring part according to claim 11, wherein the conducting path is formed by a through hole.

13. The flooring part according to claim 6, wherein a combination of the first and second foil layers as a whole is water resistant.

14. A device for detecting a pressure comprising:
a first foil layer, provided with at least a first electric conductor and at least a second electric conductor, electrically isolated from each other;
a second foil layer, comprising an electric resistance;
wherein the first layer and the second layer are arranged on top of each other, such that the respective sides with the at least one first and second electric conductor and the resistance face each other, and are dimensioned such that a projection of the location of the electrical resistance on the first layer covers an area to which both the at least one first and second electric conductor extend;
a separator, for keeping the first and the second layer at least locally at a distance from each other when there is no pressure applied to the device;
at least a first connector point, electrically coupled to the first electric conductor, and outwardly available at a first pair of opposite sides of the device;
and at least a second connector point, electrically coupled to the second electric conductor, and outwardly available at a second pair of opposite sides of the device.

15. (canceled)

16. The system according to claim 1, wherein the interconnector comprises an extended shape to accommodate flooring part patterns.

17. The system according to claim 1, wherein the adhesive is a waterproof adhesive.

18. The device according to claim 14,
wherein the device is extended by a grounded electrode separated by a PVDF layer to simultaneously measure a body or a pressure dependent capacitance.

19. The system according to claim 1, wherein the substrate is a floor.

20. The system according to claim 16, wherein the flooring patterns are brick or ashlar.
